(19) United States
(12) Patent Application Publication
(10) Pub. No.: US 2020/0094616 A1
(43) Pub. Date: Mar. 26, 2020

(54) ADJUSTABLE AIRLESS TIRE WITH A PISTON SYSTEM

(71) Applicants: Hai Huang, (US); Tony Huang, (US)

(72) Inventors: Hai Huang, Herndon, VA (US); Tony Huang, Herndon, VA (US)

(73) Assignees: Hai Huang, Herndon, VA (US); Tony Huang, Herndon, VA (US)

(21) Appl. No.: 16/183,681

(22) Filed: Nov. 7, 2018

Related U.S. Application Data
(63) Continuation-in-part of application No. 16/137,436, filed on Sep. 20, 2018.

(51) Int. Cl. B60B 9/24; B60B 9/20

(52) U.S. Cl. CPC B60B 9/24; B60B 9/20

(57) ABSTRACT

An adjustable airless tire with a piston system includes a fluid container connecting with a plurality of spoke structure of pistons to transfer a load of a vehicle from a ground contact surface of a tire to whole walls of the tire. A sensor detects a tension of the tire and a variation of the tension during driving. A control component adjusts the tension of the tire according the load of the vehicle and the road conditions to improve its fuel efficiency, comfortability, controllability and safety. A rim of a wheel keeps an appropriate distance from the tire to limit the maximal level of downward movement of the supporting rods, and support the load of the vehicle if the tire is overload or the piston system lose their function. A transversely curved tire forms closed space between the tire and the rim of the wheel to prevent sticking of foreign objects between them.

### CROSS-REFERENCES TO RELATED APPLICATIONS

This application claims priority to U.S. patent application Ser. No. 16/137,436 filed on Sep. 20, 2018, the entire contents of all of which are incorporated herein by reference.

### FIELD OF THE DISCLOSURE

The present disclosure generally relates to the field of an adjustable airless tire with a piston system and, more particularly, relates to a system of the adjustable airless tire with a plurality of spoke structure of the pistons to imitate an internal inflated tire, and a sensor and a control component to detect and regulate a tension of the tire according road conditions, which possess its advantages of fuel economy, comfortability, controllability and safety.

### BACKGROUND

Current internal inflated tires provide high suspension capabilities for a vehicle by transferring a load of the vehicle from a ground contact surface of a tire to whole walls of the tires through air within the tires. But, the biggest disadvantage for the internal inflated tires is air leaking.

Nowadays, there are several types of airless tires. But, they cannot transfer the vehicle load from the ground contact surface to whole walls of the tires, and just provides limited buffering for the vehicle from the ground contact surface of the tires. In addition, they need special materials that must have enough hardness to support the heavy load of the vehicle as well as enough elastic to provide good suspension for the vehicle. As the result, they will be expensive.

Road conditions may be different, such as a rough road or slippery one, which need different tension of the tire to keep comfortability, stability and safety during driving. But, current tires cannot adjust the tension of the tire according changes of the load of the vehicle or the road conditions.

The invention designs an adjustable tire with a plurality of spoke structure of the pistons to transfer the load of the vehicle from the ground contact surface of the tire to whole walls of the tires, which imitates the internal inflated tires to provide good suspension for the vehicle. The tire is also elastomeric and easy to change. At the same time, a sensor and a control component can detect and regulate the tension of the tire according to the conditions of the road. The adjustable airless tire system in the invention improves fuel efficiency, comfortability, controllability and safety.

### BRIEF SUMMARY OF THE DISCLOSURE

The present disclosure includes an adjustable airless tire with a piston system to transfer a load of a vehicle from a ground contact surface of the tire to whole walls of the tire, which imitates a mechanism of an internal inflated tire to provide good suspension.

At the same time, by detecting a tension of the tire with a sensor, a control component will regulate pressure of fluid within the piston system to control the tension of the tire. As the result, a size of the ground contact surface of the tire will change according the load of the vehicle or road situations, which improve its fuel efficiency, comfortability, controllability and safety during driving.

Utilizing any suitable elastomer and all types of reinforcing materials as similar as the internal inflated tire, the tire is cost effectiveness and affordable. Its curved shape provides a closed space between a rim of a wheel and the tire to prevent foreign objects sticking between them.

Other aspects or embodiments of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 is a view schematically showing an adjustable airless tire with a piston system related to the present invention.

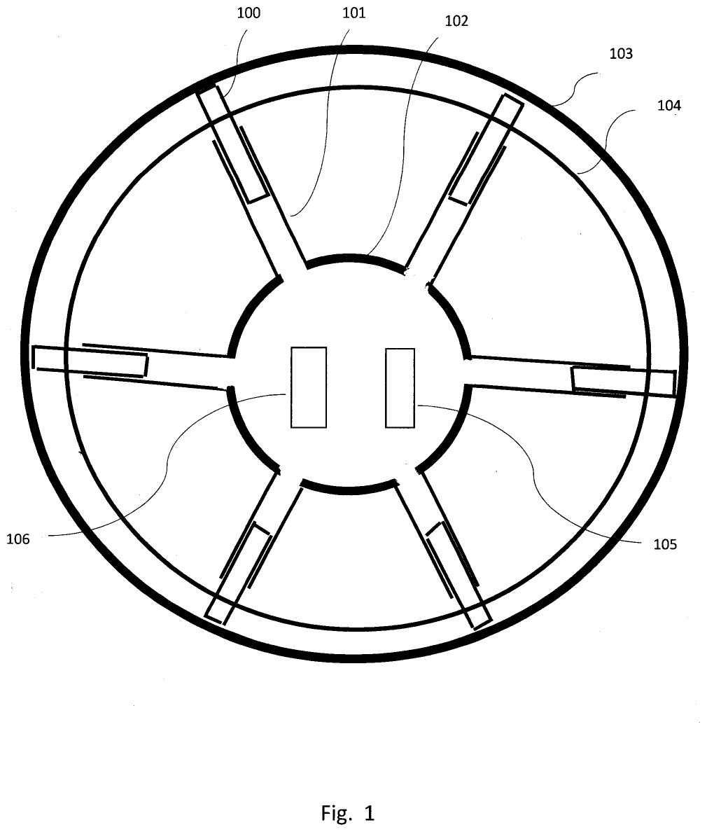

### DETAILED DESCRIPTION

Reference will now be made in detail to exemplary embodiments of the disclosure, which are illustrated in the accompanying drawings. Wherever possible, the same reference numbers will be used throughout the drawings to refer to the same or like parts.

The invention contains a fluid container 102 connecting with a plurality of spoke structure of pistons 101 to transfer a load of a vehicle from a ground contact surface of a tire 103 to whole walls of the tire, which imitates an internal inflated tire to provide good suspension for the vehicle.

The pistons connect with the fluid container and support walls of the tire. A top of piston rods 100 is fixed with a curved plate to better support the walls of the tire. The fluid materials within the piston system can be oil or other suitable fluids. As the ground contact surface of the tire compress the corresponding loaded piston rods, they will transfer a pressure of fluid from the corresponding loaded pistons to all other pistons through the fluid within the container, which cause other piston rods moving upward to compress other parts of the walls of the tires. By this way, the load of the vehicle is transferred from the ground contact surface of the tire to whole walls of the tire through the piston system, which imitates the mechanism of an internal inflated tire to provide good suspension.

A sensor 105 and a control component 106 are installed within the fluid container. The sensor will detect a fluid pressure of the fluid to calculate the tension of the tire and the load of the vehicle, and will give alert if the tire is overloaded. It also detects a variation of the fluid pressure during driving to judge road condition. An increased variation of the fluid pressure during driving suggests rougher condition of the road.

The control component can regulate the fluid pressure within the fluid container to regulate the tension of the tire through the piston rods. Regulating the tension of the tire will improve fuel efficiency, comfortability, controllability and safety during driving. First, according the load of the vehicle to regulate the tension of the tire can optimize a size of the ground contact surface of the tire with the road, which will reduce rolling resistance and improves fuel efficiency; Second, driving on the rough road, severe shaking of the tire will increase the variation of the fluid pressure. Reducing the tension of the tire with the control component will reduce riding vibration and create a softer ride to improve the comfortability; Third, driving on a slippery road condition, such as raining or snowing, decreasing the tension of the tire will increase the size of the ground contact surface of the tire with the road, which improves the controllability and safety of the vehicle during driving; Fourth, driving on sand or mud terrain, increasing the size of the ground contact surface of the tire will decrease pressure of the tire on the ground, which reduces sinking of the tire into sand or mud. It also improves traction of the tire over loose surfaces. Fifth, at emergency situation, the increased size of the ground contact surface of the tire will increase frictional resistance between the ground and the tire, which decreases braking distance.

A steel rim of the wheel keeps appropriate distance from the tire to limit the maximal level of downward movement of the piston rods, and support the load of the vehicle if the tire is overload or the piston rods lose their function. The steel rim is supported from steel frames with their one ends fixed at center area of the wheel.

The tire is made of any suitable elastomer with all types of reinforcing materials that may be similar as the internal inflated tire to help support the load of the vehicle and enhance its performance. A transverse shape of the tire is curved as the internal inflated tires to form closed space between the tire and the rim of the wheel with its two sides mounted within rim flanges of the wheel, which prevents foreign objects, such as stones, from sticking between the tire and the rim during driving.

Other applications, advantages, alternations, modifications, or equivalents to the disclosed embodiments are obvious to those skilled in the art and are intended to be encompassed within the scope of the present disclosure.

What is claimed is:

1. An adjustable airless tire with a piston system comprising:
a plurality of spoke structure of pistons connecting with a fluid container at a central area of a wheel and supporting walls of a tire with their piston rods;
The fluid within the piston system can be oil or other suitable fluids;
a sensor and a control component are installed within the fluid container;
a rim of a wheel keeping appropriate distance from the tire; and
the tire transversely being curved to make a closed space between the tire and the rim of the wheel.

2. The adjustable airless tire with a piston system according to claim 1, wherein the piston rods comprise a curved plate at its end to support the walls of the tire, and the pistons connect with the fluid container.

3. The adjustable airless tire with a piston system according to claim 1, wherein the fluid within the piston system can be oil or other suitable fluids, which transfer pressures of the fluid from the loaded pistons to other pistons through the fluid container, and distributes the load of the vehicle from the ground contact surface of the tire to whole walls of the tire.

4. The adjustable airless tire with a piston system according to claim 1, wherein the sensor detects the tension of the tire to calculate the load of the vehicle, and a variation of the tension of the tire during driving to estimate roughness of a road.

5. The adjustable airless tire with a piston system according to claim 1, wherein the control component regulates the pressure of the fluid within the fluid container, which affects the tension of the tire.

6. The adjustable airless tire with a piston system according to claim 1, wherein the rim of the wheel keeps an appropriate distance from the tire to limit the maximal level of downward movement of the piston rods, and supports the load of the vehicle if the tire is overloaded or the piston system loses their function.

7. The adjustable airless tire with a piston system according to claim 1, wherein the tire is elastomeric with all types of reinforcing materials, and with its transversely curved shape to make a closed space between the tire and the rim of the wheel.
